(19) United States
(12) Patent Application Publication
(10) Pub. No.: US 2011/0289890 A1
(43) Pub. Date: Dec. 1, 2011

(54) Product Dispensing Device

(76) Inventors: Brian Lee Floyd, Cincinnati, OH (US); Ian Andrew Carnduff, New York, NY (US); Paul Frank Diehl, Brooklyn, NY (US); Graham Clive Hufton, New York, NY (US)

(21) Appl. No.: 13/113,262

(22) Filed: May 23, 2011

Related U.S. Application Data
(60) Provisional application No. 61/349,074, filed on May 27, 2010.

(51) Int. Cl. B65B 43/00; B67D 7/06

(52) U.S. Cl. 53/492; 222/25

(57) ABSTRACT

A dispensing device comprising at least one pair of indicia on separate structures which are rotatable with respect to one another, wherein the indicia have corresponding shapes such that alignment or unalignment of the corresponding shapes puts the device in a locked or unlocked position.

### CROSS REFERENCE TO RELATED APPLICATIONS

This application claims the benefit of U.S. Provisional Application No. 61/349,074 filed May 27, 2010.

### BACKGROUND OF THE INVENTION

The use of locking systems to make dispensing containers “child proof” of lockable is known. Many manufacturers of aerosol dispensing containers have used rotatable members on the cap or actuating system to allow for a locked and unlocked position. For example, some manufacturers have described camless aerosol valve actuators with a top portion mounted on and rotatable with respect to a bottom portion. See e.g., U.S. Pat. No. 6,758,373 to Jackson. Other manufacturers have described aerosol dispensers with rotating intermediate members which rotate about the container and top member. See e.g., U.S. Pat. Nos. 3,721,423 to Shay; 5,385,303 to Gosselin; and 7,222,754 to Ho.

Recently, the use of rotatable overcaps on aerosol dispensers has been described. See e.g., U.S. Patent Publ. Nos. 2008/0041889 to Geier, 2007/0039979 to Strand et al, and U.S. Pat. No. 5,649,645 to Demarest. These recent developments in overcap assemblies however, are designed to allow an overcap to be rotated with respect to an actuator, providing for an open position where the dispensing orifice or nozzle of the actuator is exposed and a closed position where the dispensing orifice or nozzle is covered.

One of the problems with these types of overcap assemblies is that it is difficult to access the area of around the dispensing orifice or nozzle because it is set back from the overcap when in an open position or covered when in a closed position.

Despite the many different types of locking systems for aerosol and other dispensing devices, they typically use alignment lines or arrows, or “open” or “close” directional arrows. Because of the proliferation of these similar tools to show the open and close position, they become less and less effective as child proofing tools. Further, many users use these systems in suboptimum lighting conditions (i.e., in the morning hours or poorly lit restrooms or homes). Furthermore, as the population age, vision can become compromised making small arrows or wordings difficult to make out and align. As such, there is a need for a new cap system for an aerosol or pump dispensing device which is easier to unlock but does not use the basic alignment systems described in the past.

### SUMMARY OF THE INVENTION

The present invention has importantly been able to address one or more of the problems encountered with dispensing devices of the past by providing a dispensing device for containing and dispensing a fluid, said dispensing device comprising: a container comprising an upper rim and a reservoir; an actuator system in operable contact with said reservoir through said upper rim, said actuator system comprising a top member comprising an actuator indicia, said intermediate member between said top member and said container, said intermediate member comprising a intermediate member indicia corresponding to said actuator indicia, wherein at least one of said top member and said intermediate member is rotatable to allow said actuator indicia and said intermediate member indicia to align to form an unlocked position.

Another aspect of the present invention provides for an actuator system for use with a dispensing container, comprising an top member in operable contact with said reservoir through said upper rim, said top member having a actuator indicia; and a intermediate member removably attached to said upper rim of said container, said intermediate member having a intermediate member indicia corresponding to said actuator indicia, wherein at least one of said top member and said intermediate member is rotatable to allow said actuator indicia and said intermediate member indicia to align to form an unlocked position.

Yet another aspect of the present invention provides for a method of unlocking a dispensing device comprising the steps of: at least partially rotating either a intermediate member about an top member or an top member about a intermediate member to align at least one indicia present on said intermediate member with an indicia present on said top member, wherein said intermediate member indicia corresponds to said actuator indicia, thereby unlocking said dispensing container.

### BRIEF DESCRIPTION OF THE DRAWINGS

FIG. 1a shows a side view of a dispensing device in accordance with at least one embodiment of the present invention.

FIG. 1b shows a side view of the device shown in FIG. 1a, wherein either the top member or the intermediate member is at least partially rotated with respect to the other.

FIG. 2a shows a side view of an actuator system and intermediate member in accordance with at least one embodiment of the present invention.

FIG. 2b shows a side view of the actuator system and intermediate member shown in FIG. 2a, wherein the either the top member or the intermediate member is partially rotated with respect to the other.

FIG. 2c shows a side view of the actuator system and intermediate member shown in FIGS. 2a and 2b wherein a downward pressure is applied to the top member.

FIG. 3a shows a side view of an actuator system and intermediate member in accordance with at least one embodiment of the present invention.

FIG. 3b shows a side view of the actuator system and intermediate member shown in FIG. 3a, wherein the either the top member or the intermediate member is partially rotated with respect to the other.

FIG. 3c shows a side view of the actuator system and intermediate member shown in FIGS. 3a and 3b wherein a downward pressure is applied to the top member.

FIG. 4a shows a side view of an actuator system and intermediate member in accordance with at least one embodiment of the present invention.

FIG. 4b shows a side view of the actuator system and intermediate member shown in FIG. 4a, wherein the either the top member or the intermediate member is partially rotated with respect to the other.

FIG. 4c shows a side view of the actuator system and intermediate member shown in FIGS. 4a and 4b wherein a downward pressure is applied to the top member.

FIG. 5a shows a side view of an actuator system and intermediate member in accordance with at least one embodiment of the present invention.

FIG. 5b shows a side view of the actuator system and intermediate member shown in FIG. 5a, wherein the either the top member or the intermediate member is partially rotated with respect to the other.

FIG. 5c shows a side view of the actuator system and intermediate member shown in FIGS. 5a and 5b wherein a downward pressure is applied to the top member.

FIG. 6a shows a top view of an actuator system and intermediate member in accordance with at least one embodiment of the present invention.

FIG. 6b shows a top view of the actuator system and intermediate member shown in FIG. 6a, wherein the either the top member or the intermediate member is partially rotated with respect to the other.

FIG. 7a shows a side view of an actuator system and intermediate member in accordance with at least one embodiment of the present invention.

FIG. 7b shows a side view of the actuator system and intermediate member shown in FIG. 7a, wherein the either the top member or the intermediate member is partially rotated with respect to the other.

FIG. 7c shows a top view of the top member shown in FIG. 7a.

### DETAILED DESCRIPTION OF THE INVENTION

### 1. Dispensing Device

A dispensing device of the present invention is suitable for containing and dispensing a fluid, said dispensing device comprising: a container comprising an upper rim and a reservoir; an actuator system comprising a discharge member in fluid communication with said reservoir through said upper rim, an actuating member, a top member having a actuator indicia; and a intermediate member removably attached to said upper rim of said container, said intermediate member having a intermediate member indicia corresponding to said actuator indicia, wherein at least one of said top member and said intermediate member is rotatable to allow said actuator indicia and said intermediate member indicia to align to form an unlocked position. “Corresponding shapes” as defined herein, and described in further detail below, means that at least one of said actuator indicia and said intermediate member indicia are designed to mate in a yin yang or male/female manner such that the user can recognize that when they are aligned, the device is in an unlocked position and the actuator can be triggered, such as by depressing or by triggering.

In one embodiment, the intermediate member is a collar. Those of skill in the art will understand that the actuator system can also include commonly used elements such as tubes, valves, springs, etc to allow fluid to be transported from the reservoir through the device out of a discharge member. The discharge member is preferably present on part of the actuator system, such as on the top member or on the intermediate member. The actuating member can be present on the top end or can be present on the intermediate member. In one embodiment, the actuating member can be a trigger such as a spray trigger which can extend out of a spray head, similar to a Febreze Air Effects trigger sprayer.

Non-limiting examples of suitable dispensing devices for use herein include aerosol and non-aerosol cans, pumps, sprays, atomizers, and so forth. These devices can be manual or automatic as long as they include the locking and unlocking features of the actuator system of the present invention. Although the actuator system is generally described herein to assist in locking and unlocking the device, the indicia used on the top member and the intermediate member can also be used for other features, such as controlling the volume, intensity or dispersion of the product being dispensed (i.e., stream vs. spray vs. mist). The indicia can also be used to control different power or modulation settings such as a fast pulse or irregular pulse. Examples of internal pump/aerosol parts which can be used in accordance with the actuator system of the present invention include those devices described in the background of this document, as well as any related devices known in the art.

In one embodiment, the intermediate member at least partially rotates with respect to the top member and/or the rest of the device to unlock the actuator system. In another embodiment, the top member at least partially rotates with respect to the color and/or the rest of the device to unlock the actuator system. In yet another embodiment, both the intermediate member and the top member can rotate in the same direction or opposing directions. Those of skill in the art will understand that as long as at least one of the top member and the intermediate member can at least partially rotate with respect to the other, the actuator system can be made to be in a locked or unlocked condition. In one embodiment, one of the top member or the intermediate member is in a fixed position with respect to the container, meaning that it does not rotate with respect to the container. In another embodiment, one of the top member and intermediate member can be removably or permanently fixed to the device. In yet another embodiment, the container or a part thereof, forms either the intermediate member or the top member.

In one embodiment, the dispensing device is in a locked position when said actuator indicia and said intermediate member indicia are not aligned. The alignment of the indicia will be described hereinafter. In one embodiment, the intermediate member and top member are separated by a coupling member. In another embodiment, a portion of the intermediate member and a portion of the top member can be in direct contact.

In another embodiment, the actuator system comprises a discharge member, wherein said actuator indicia is positioned in the vicinity of said discharge member. In one embodiment, the discharge member can be formed in the intermediate member, and/or in the top member. The discharge member may be a dispensing orifice, drain, aperture or other dispensing device, as is known in the art. A nozzle will be discussed for exemplary and illustrative purposes. The nozzle may be pressed or otherwise displaced from its normally closed position to provide a flow path for material disposed in the container to the environment. For example, one suitable type of nozzle is a normally closed spray orifice. Alternatively a trigger, cam, etc. may be utilized to open the flow path for product disposed inside one container to be dispensed to the environment. Suitable nozzle are disclosed in U.S. Pat. Nos. 3,690,515 issued to Ewald, 4,940,170 issued to Popp-Ginsbach, 4,964,539 issued to Mueller, 5,497,911 issued to Ellion et al. and 5,839,623 issued to Losenno et al.

The container is preferably made of a glass, metal, plastic material or combination thereof. In one embodiment, at least a portion of the container, such as the outer shell, can be made of a metal such as tin or aluminum. Plastic materials suitable for use with the device of the present invention include, but are not limited to: polypropylene (PP), polyethylene (PE), polyethylene napthylate (PEN), polycarbonate (PC), polyamides (PA) and/or polyethylene terephthalate (PET), polyvinylchloride (PVC); and polystyrene (PS). In one embodiment, at least a portion of the container is rigid. A rigid container is believed to provide protection in the event that the device is dropped, or otherwise disturbed. The container should have an outer wall with any wall thickness suitable for the intended pressurization.

In one embodiment, at least a portion of the device can be made of a translucent or clear material. A translucent or clear container body would allow a user to see the contents of the device, such as the reservoir. Where the reservoir is clear or translucent, the user can actually see the contents as well.

### 2. Actuator System

The actuator system of the present invention comprises a top member. In one embodiment, the top member forms a portion of the top of the container distal to the upper rim of the container when the actuator system is attached to the container. The top member can be just a top surface but can also include a rim hanging down from the top surface towards the intermediate member which is present between the actuator system and the container. In one embodiment, the actuator system further comprises an actuator member. Non-limiting examples of suitable actuator members include depressible buttons, depressible spray heads, triggers, and other actuator members typically used for aerosols and/or spray pumps. In one embodiment, the actuator member can be a depressible structure which can include the top end, the discharge member, or a combination thereof. In another embodiment, the top member is not depressible and the actuator system can include a separate depressible or trigger member. Non-limiting examples of suitable dispensing systems having actuators include those disclosed in: U.S. Pat. Nos. 5,829,641; 6,981,658; 5,642,860, and U.S. Patent Publ. 2004/0222246. Those of skill in the art will understand that these and other known dispensing systems having actuators can be adapted to include the actuator indicia and the intermediate member indicia to allow the devices to be locked and unlocked by the user.

In one embodiment, the actuator comprises more than one actuator indicia. The plurality of actuator indicia can be identical, such as having the same shape (triangles, rectangles, semicircles, etc) but they can also have varying shapes. In another embodiment, the intermediate member comprises more than one intermediate member indicia. Similarly, the plurality of intermediate member indicia can also be identical or have varying shapes, so long as at least one of the actuator indicia and the intermediate member indicia are corresponding so a user will know when the device is properly rotated and aligned to unlock.

In one embodiment, one of said actuator indicia covers an angle of from about 10 degrees to about 360 degrees of the periphery of the top member, or from about 15 degrees to about 45 degrees, or from about 20 degrees to about 30 degrees. The angle covered by the indicia is measured from the center point of the actuator top member. Where the center point is not easily determined, it is the center of gravity of the top member. In another embodiment, the intermediate member comprises more than one intermediate member indicia. The intermediate member indicia can have cover similar angles as described previously with respect to the actuator indicia. In another embodiment, the actuator indicia and the intermediate member indicia cover the substantially the same angle, for example within 5 degrees, or even 2 degrees of each other. In one embodiment, the indicia cover the same angle. Without intending to be bound by theory, it is believed that indicia covering such portions of the visible portion of the actuator system allow the users to identify and easily align and unalign the indicia as desired to lock and unlock the dispensing device.

In one embodiment, where a plurality of actuator indicia is present, they can be equally spaced apart circumferentially. Alternatively, the actuator indicia can be spaced apart unequally. In one embodiment, the intermediate member indicia can be equally spaced apart circumferentially or not. In yet another embodiment, the actuator indicia and the intermediate member indicia are not the same in number. The actuator indicia and the intermediate member indicia need not both be spaced apart with the same alignment. Those of skill in the art will understand that as long as at least one of said actuator indicia and at least one of said intermediate member indicia correspond, they can be aligned to allow the device to be placed in an unlocked and ready to use position.

In one embodiment, the top member comprises a top end and a side wall extending from a top end towards said container, wherein said actuator indicia is at least partially on said side wall. The actuator indicia can also be formed or located entirely on the side wall. In another embodiment, where a side wall is not present, the actuator indicia can be present just on the top end of the actuator.

### 3. Intermediate Member

In one embodiment, the dispensing device comprises an intermediate member positioned between the actuator system and the container. The intermediate member is in operative contact with said actuator system such that when the indicia on the actuator system and the intermediate member are aligned, the device is in an unlocked and ready to dispense state. When the indicia are not aligned, they device is therefore locked. In one embodiment, the intermediate member is one or more collars. Where multiple collars are used, the collars can combine to form the intermediate member indicia.

The intermediate member forms at least one intermediate member indicia which corresponds to at least one actuator indicia. As explained above, a plurality of intermediate member indicia can also be used, with the same or varying shapes, and the placement of the indicia can be dispersed equally circumferentially or unequally about the intermediate member.

### 4. Indicia Having Corresponding Shapes

The actuator system and the intermediate member each comprises at least one indicia, wherein the indicia have corresponding shapes. In one embodiment, the actuator indicia can have a concave shape (such as a cutout extending towards said top member if present on the rim, or towards the center of the top member if present on the top member), a convex shape (such as a bulge extending towards said intermediate member), or a combination thereof (such as a sigmoid shape). The intermediate member comprises an indicia which corresponds to said actuator indicia and when aligned allow the device to be in an unlocked state. In one embodiment, when the device is unlocked, the actuator member, or a part thereof can be depressed allowing the actuator indicia to move towards the corresponding intermediate member indicia.

In one embodiment, the intermediate member indicia comprises a shape which mates with the shape of the actuator indicia in a male/female or vice versa fashion. In another embodiment, the indicia can correspond in that they meet to form a larger shape, such as two semicircles or portions of a discernable shape which extends across the actuator system and the intermediate member. Preferably the discernable shape is continuous between the two structures in that a user seeing the indicia in an aligned position will recognize that the two indicia form a larger discernable shape. The discernable shape can be regular (such as a circle, star, square, triangle) or can be irregular such as a wave, moon, letter/number or word shape).

In one embodiment, one or both of the actuator indicia and the intermediate member indicia which correspond in shape can be three dimensional structures formed in the respective portion of the actuator system and intermediate member, or they can be two dimensional and be colors or labels present on the exterior of the actuator system and intermediate member. Where a plurality of indicia are used, they can include two dimensional and three dimensional indicia.

Alignment of the actuator indicia and the intermediate member indicia can be achieved by rotation of either the actuator or the intermediate member. In one embodiment, only one of these two structures rotates and the other structure can be in a fixed position with respect to the container. In yet another embodiment, where the actuator system includes a top member and a rim, the top member can stay stationary, and the rim can rotate to allow the indicia to become aligned.

### 5. Methods of Use

A method of unlocking a dispensing container comprising the steps of: at least partially rotating either a intermediate member about an top member or an top member about a intermediate member to align at least one indicia present on said intermediate member with an indicia present on said top member, wherein said intermediate member indicia corresponds to said actuator indicia, thereby unlocking said dispensing container. Once the indicia are aligned, the device is in an unlocked state and can be used to dispense fluid contained in the container. The fluid will be dispensed from the container through a discharge member.

### 6. Compositions

As explained above, the device can be used for dispensing various types of particles and fluids. In one embodiment, the device is an aerosol dispenser. Suitable compositions for use in an aerosol will be recognized by those of skill in the art and non-limiting examples include, personal care compositions such as: shave foams, post foaming shave gels, cleaning aerosols, deodorants, sun screens, lotions, hair care products, skin care treatments, fragrances and so forth; and household products such as: air fresheners, hard surface cleaners, insect repellants, fragrances, cooking oils sprays, paints, and so forth. The device can also be a non-aerosol dispensing device such as a pump spray. Various types of pump sprays are known and can be used in accordance with the present invention. Further, the device can be used to dispense any fluid composition which is typically dispensed in pump sprayers.

In one embodiment, the device is used for dispensing a hair removal preparation such as a post foaming shave gel. The composition may be formulated as an aerosol foam, a post-foaming gel (which is the preferred form) or a non-aerosol gel or lather.

### 7. Actuator Valve Systems

Those of skill in the art will understand that various types of dispensers can be combined with the actuator member and intermediate member of the present invention, these devices include collapsible tubes, pump or squeeze containers, and aerosol-type dispensers, particularly those with a barrier to separate the post foaming gel composition from the propellant required for expulsion.

The latter type of dispensers include: (1) mechanically pressurized bag-in-sleeve systems in which a thin-walled inner bag containing the product is surrounded by an outer elastic sleeve that is expanded during the product filling process and provides dispensing power to expel the product (e.g., the ATMOS System available commercially from the Exxel Container Co.); (2) (a) a container preform comprising a polymeric preform and an elastically deformable band surrounding at least a portion of the polymeric perform such as described in U.S. 2009/0263174 to Chan et al; (3) manually activated air pump spray devices in which a pump system is integrated into the container to allow the user to pressurize the container with air in order to expel the product (e.g., the “AIRSPRAY” system available from Airspray International); (4) piston barrier systems in which the product is separated from the driving means by a tight-fitting piston which seals to the side of the container and may be driven by a spring under tension, by a vacuum on the product side of the piston, by finger pressure, by gas pressure to the piston, or by a variety of other means known to the packaging industry; and (5) bag-in-can (SEPRO) systems in which the product is contained in a flexible bag within a can, with a suitable propellant injected into the space between the can and the flexible bag. It is preferred to protect the composition from oxidation and heavy metal contamination. This can be achieved, for example, by purging the composition and container with nitrogen to remove oxygen and by utilizing inert containers (e.g., plastic bottles or bags, aluminum cans or polymer coated or lined cans).

The present device can be used to dispense compositions in combination with various hair removal applications (prior to, concurrently with, and/or after), including but not limited to shaving (wet or dry shaving, via electric razors, via powered or manual razors which can be reusable or disposable, and combinations thereof), epilation, electrolysis, wax or depilatories as well as energy delivery devices to help regulate hair growth. Nonlimiting examples of energy deliver devices include: light, heat, sound (including ultrasonic waves and radio frequency), electrical energy, magnetic energy, electromagnetic energy (including radiofrequency waves and microwaves), and combinations thereof. The light energy may be delivered by devices including, but not limited to, lasers, diode lasers, diode laser bars, diode laser arrays, flash lamps, intense pulsed light (IPL) sources, and combinations thereof. See e.g. US2006/0235370A1.

In one embodiment, the top member of the present invention further comprises a valve system and tube system such that the discharge member of the actuator is in fluid communication with the fluid contained within said reservoir. Various valve systems and tube systems are known and can be used in accordance with the present device without deviating from the present invention.

### 8. Figure Details

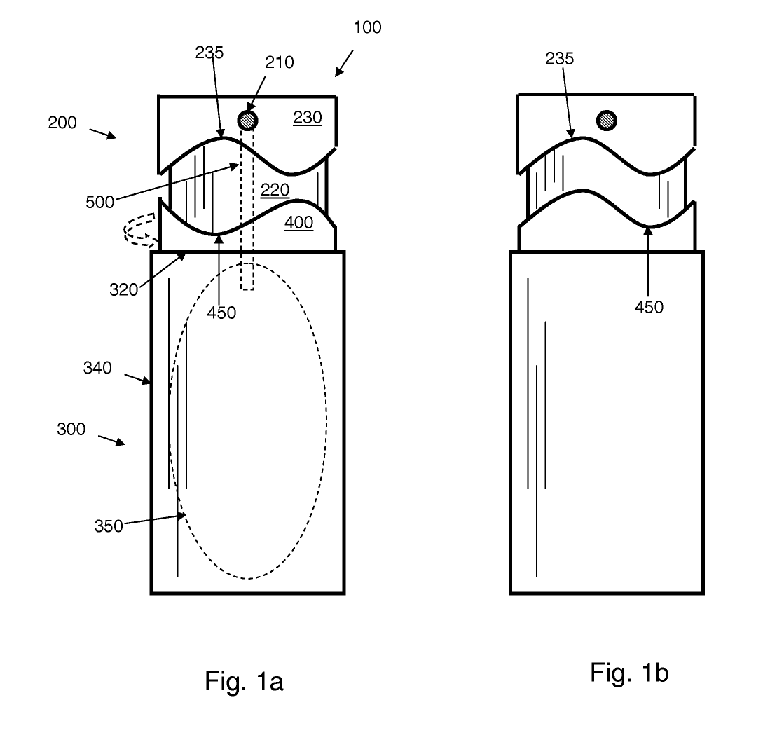

FIG. 1a shows a side view of a dispensing device (100) in accordance with at least one embodiment of the present invention. The dispensing device (100) comprises: a container (300) comprising an upper rim (320) and a reservoir (350). The container also includes an outer wall (340) with an exterior surface. The exterior surface can accommodate printing or labeling. The device also include an actuator system (200) in operable contact with said reservoir through said upper rim, said actuator system comprising a top member (230), said actuator system comprising an actuator indicia (235); and a intermediate member (400) between said top member and said container. As shown in this embodiment, the actuator member forms a discharge member (210). The actuator system and the intermediate member are separated by a neck (220). The intermediate member is removably attached to said upper rim of said container and can be rotated. The intermediate member comprising a intermediate member indicia (450) corresponding to said actuator indicia, wherein at least at least a portion of at least one of said actuator system and said intermediate member is rotatable to allow said actuator indicia and said intermediate member indicia to align to form an unlocked position. As shown by the rotation arrow, the device of this drawing allows the intermediate member to rotate with respect to the actuator system. The reservoir (350) of the device is in fluid communication with the discharge member (210) via at least a tube (500). Those of skill in the art will understand that the actuator system and locking features will also be involved with how fluid is transported from the reservoir to the discharge member. In one embodiment, the alignment or unalignment of the corresponding actuator and intermediate member indicia allow for a slot fitment or alignment of parts to allow the actuator member to be depressed. FIG. 1a shows an embodiment where the indicia is a wave shape which is not aligned, and thereby putting the device in a locked and non-dispensing configuration. FIG. 1b shows a side view of the device shown in FIG. 1a, wherein the intermediate member is rotated to allow the actuator indicia and the intermediate member indicial to align. In this embodiment, the actuator indicia includes a concave shape extending towards the discharge member and away from the intermediate member and a convex shape extending away from the discharge member and towards the intermediate member.

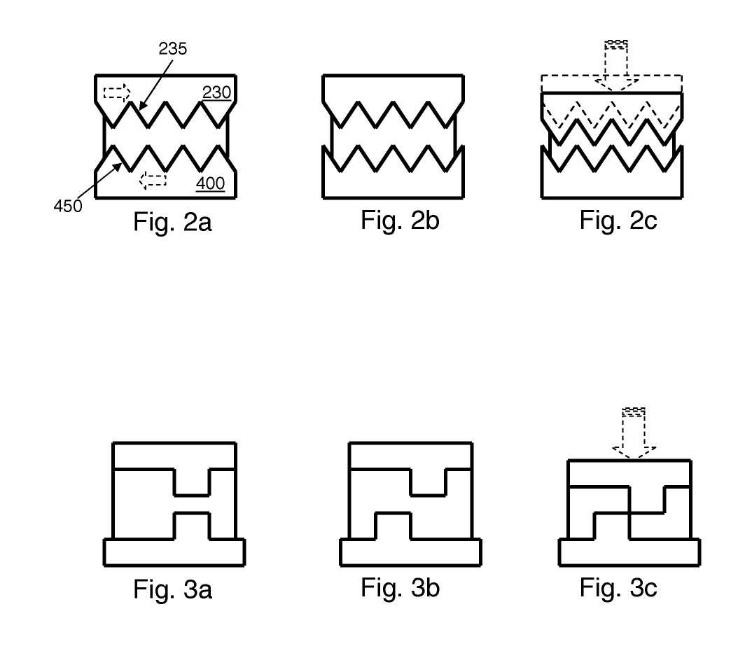

FIG. 2a shows a side view of an actuator system and intermediate member in accordance with at least one embodiment of the present invention. The actuator indicia (235) and the intermediate member indicia (450) are a set of corresponding triangles. Each triangle can be counted as individual indicia. In this embodiment, the entire set of triangles can be counted as a single indicia or as a plurality of indicia. In this embodiment, the arrows show that both the actuator member and the intermediate member can be rotated to align the corresponding indicia. FIG. 2b shows a side view of the actuator system and intermediate member shown in FIG. 2a, wherein the either the top member or the intermediate member is partially rotated with respect to the other. The indicia are rotated such that the actuator system can be depressed as shown in FIG. 2c.

FIGS. 3a, 3b, and 3c shows another embodiment where the actuator indicia is a rectangular shape. The intermediate member indicia is also a rectangular shape. In a locked position, the corresponding indicia would come into contact and block each other. In an unlocked position (FIGS. 3b and 3c) the indicia are rotated to allow each other to fit without blocking when the actuator member is depressed. In this embodiment, the indicia do not need to extend beyond the closest point of the other corresponding indicia.

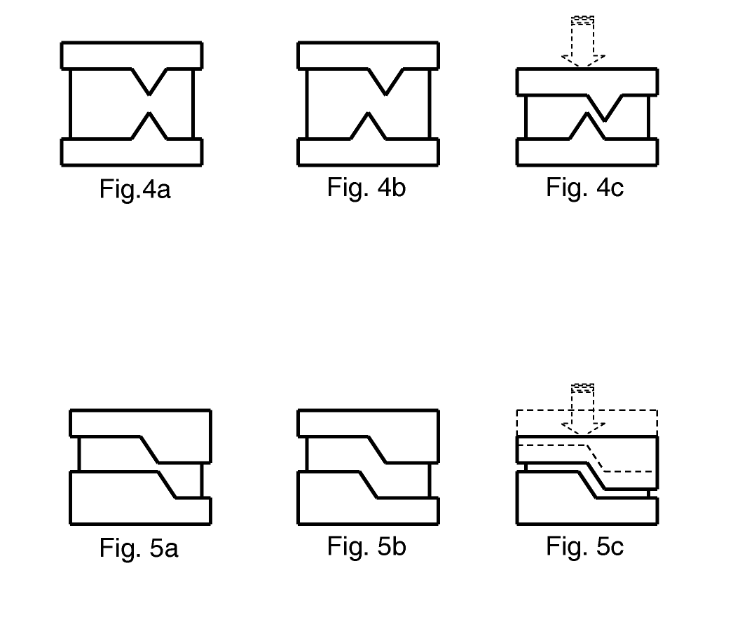

FIGS. 4a, 4b, and 4c, show similar devices, where the indicia include triangles but can extend beyond the closest point of the other corresponding indicia when actuated. In one embodiment, the actuation can be such that the top member is depressed to the point that the actuator indicia comes into contact with the intermediate member. FIGS. 5a, 5b, and 5c show a step design in the indicia.

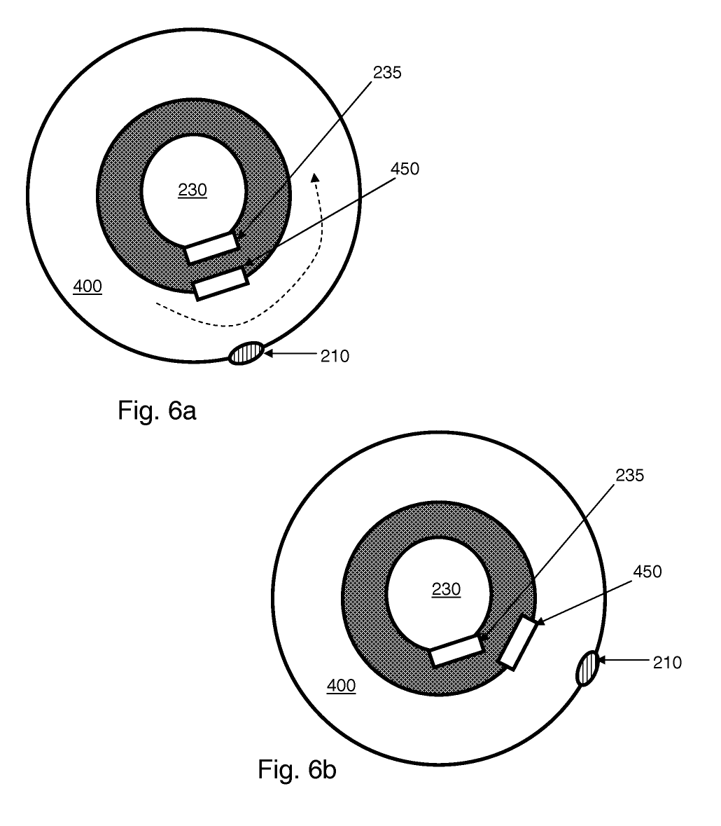

FIG. 6a shows a top view of an actuator system having a top member (230) and an intermediate member (400) in accordance with at least one embodiment of the present invention. As shown here, the indicia can be present on the top plane of the device such that they are visible when the device is placed with its major axis perpendicular to the plane of viewing. In this embodiment, the intermediate member forms part of the top of the device, meaning that it extends from the collar up onto the top of the device. As such, if the top member is also the actuating member, depressing the top member would not move the top member towards the intermediate member, rather the top member would be depressed towards the upper rim of the container. In this embodiment, the discharge member (210) is formed or is surrounded by the intermediate member. In this embodiment, the top member (230) is adjacent to and/or forms an actuator indicia (235). The intermediate member is adjacent to and/or forms an intermediate member indicia (450). In one embodiment, the device shown in 6a can be the locked position. Alternatively, the 6a device can be the unlocked position, and the 6b configuration can be the locked position.

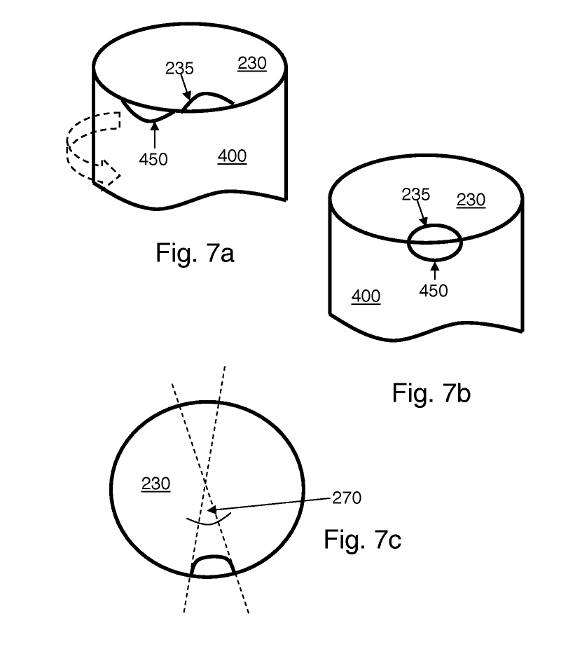

FIGS. 7a and 7b show a side view of an actuator system without a rim extending from said top member towards said intermediate member and an intermediate member in accordance with at least one embodiment of the present invention. The actuator indicia (235) is a semicircle which can form a circular shape with the intermediate member indicia (450) when the indicia are aligned. Alignment of the indicia can be the locked or unlocked position. FIG. 7c shows a top view of the top member shown in FIG. 7a, wherein at least one of said actuator indicia and said intermediate member indicia covers an angle (270) of from about 10 degrees to about 360 degrees of the periphery of the respective actuator or intermediate member, as measured from the center of the top member (230).

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified. Except as otherwise noted, the articles “a,” “an,” and ^{the} mean “one or more.”

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A dispensing device for containing and dispensing a fluid, said dispensing device comprising:
a. a container comprising an upper rim and a reservoir;
b. an actuator system in operable contact with said reservoir through said upper rim, said actuator system comprising a top member, said actuator system comprising an actuator indicia; and
c. a intermediate member between said top member and said container, said intermediate member being removably attached to said upper rim of said container, said intermediate member comprising a intermediate member indicia corresponding to said actuator indicia,
wherein at least a portion of at least one of said actuator system and said intermediate member is rotatable to allow said actuator indicia and said intermediate member indicia to align to form an unlocked position.

2. The dispensing device of claim 1, wherein said dispensing device is in a locked position when said actuator indicia and said intermediate member indicia are not aligned.

3. The dispensing device of claim 1, wherein said actuator system comprises a discharge member, wherein said actuator indicia is positioned in the vicinity of said discharge member.

4. The dispensing device of claim 1, wherein at least one of said actuator indicia and said intermediate member indicia covers an angle of from about 10 degrees to about 360 degrees of the periphery of the respective actuator or intermediate member, as measured from the center of the top member.

5. The dispensing device of claim 1, wherein said top member comprises a top end and a side wall extending from a top end towards said container , wherein said actuator indicia is at least partially on said side wall.

6. The dispensing device of claim 1, wherein said actuator system further comprises a rim extending from said top member towards said intermediate member.

7. The dispensing device of claim 6, wherein at least a portion of said actuator indicia is on said rim.

8. The dispensing device of claim 1, wherein said actuator system comprises a plurality of actuator indicia.

9. The dispensing device of claim 8, wherein said plurality of actuator indicia are not identical.

10. The dispensing device of claim 8, wherein said plurality of actuator indicia are equally spaced apart circumferentially.

11. The dispensing device of claim 1, wherein said intermediate member comprises a plurality of intermediate member indicia.

12. The dispensing device of claim 11, wherein said plurality of intermediate member indicia are not identical.

13. The dispensing device of claim 11, wherein said plurality of intermediate member indicia are equally spaced apart circumferentially.

14. The dispensing device of claim 1, wherein said actuator indicia comprises a concave shape, a convex shape, or a combination thereof.

15. The dispensing device of claim 14, wherein said intermediate member indicia comprises a shape which mates with the shape of the actuator indicia.

16. The dispensing device of claim 1, wherein said actuator indicia and said intermediate member indicia form a discernable shape when aligned.

17. The dispensing device of claim 1, wherein at least one of said actuator indicia and said intermediate member indicia is not three dimensional.

18. The dispensing device of claim 1, wherein said top member forms a cap structure.

19. An apparatus for use on a dispensing container comprising,
a. actuator system comprising a top member and an optional rim extending towards said intermediate member, said actuator system comprising an actuator indicia; and
b. a intermediate member operably connected to said actuator system opposite said top member, said intermediate member comprising a intermediate member indicia corresponding to said actuator indicia,
wherein at least at least a portion of at least one of said actuator system and said intermediate member is rotatable to allow said actuator indicia and said intermediate member indicia to align to form an unlocked position.

20. A method of unlocking a dispensing container comprising the steps of:
a. at least partially rotating either a intermediate member about an top member or an top member about a intermediate member to align at least one indicia present on said intermediate member with an indicia present on said top member, wherein said intermediate member indicia corresponds to said actuator indicia, thereby unlocking said dispensing container.
